(19) United States
(12) Patent Application Publication
(10) Pub. No.: US 2016/0165939 A1
(43) Pub. Date: Jun. 16, 2016

(54) STEVIA COATED SUGAR GRANULES AND METHOD OF MANUFACTURING THE SAME

(71) Applicant: George W. Berry, Carriere, MS (US)

(72) Inventor: George W. Berry, Carriere, MS (US)

(73) Assignee: Eco Sweeteners LLC

(21) Appl. No.: 14/948,304

(22) Filed: Nov. 21, 2015

Related U.S. Application Data
(60) Provisional application No. 62/082,739, filed on Nov. 21, 2014.

(51) Int. Cl. A23L 1/236

(52) U.S. Cl. CPC A23L 1/2363; A23L 1/22016; A23V 2002/00

(57) ABSTRACT

A low-calorie sweetener composition, and method of manufacturing the same. The method includes providing a first sweetener having a mean particle size of between 100-350 μm in diameter and coating the first sweetener with a second sweetener in an aqueous solution. The second sweetener including at least one steviol glycoside. The sweetener composition optimally includes table sugar having a mean granular size of 100-300 μm as the first sweetener and the second sweetener is a steviol glycoside including Rebaudioside A having a 95% or greater purity coating with a thickness of 0.1-20 μm. The preferred composition has less than 2% steviol glycoside on a dry weight basis.

### PRIORITY CLAIM

This patent application claims the benefit of U.S. Provisional Patent Application No. 62/082,739 filed on Nov. 21, 2014, the disclosure of which is incorporated herein by reference.

### FIELD OF THE INVENTION

The invention relates to compositions of stevia-based sweeteners and methods of producing the same.

### BACKGROUND

Table sugar sold at retail is sucrose and often consists of equal parts glucose and fructose. Table sugar has an established standard of sweetness which is widely recognized in the food and beverage industry. It can be derived from sugar cane, sugar beets, or other plants. However, there are questions whether a diet high in sugar, especially refined sugar, is detrimental for human health.

Research suggests that sugar overconsumption is linked to obesity, diabetes, cardiovascular disease, dementia, macular degeneration, and tooth decay.

Table sugar has about 16 calories per teaspoon sized (i.e. 4 gram) serving. For those concerned about caloric consumption, sugar may not be the sweetener of choice. There is currently a trend to move towards low calorie or “zero” calorie sweeteners. Many countries and regions have regulations defining permitted bounds of “zero” labeling. For example, in the U.S., the US Food and Drug Administration definitions regarding zero calorie sweeteners encompasses a 5 calorie maximum. In Europe the number is about 4 calories. Many artificial sugar substitutes are labeled with the “Zero” calorie claim, which may seem healthier to some.

Artificial sugar substitutes bearing the “Zero” calorie claim typically include a range of 2.8-3.2 calories per serving. Each serving has the sweetening capability of one serving of sugar. Unfortunately, artificial sugar substitutes are not always healthy.

High intensity sweeteners including saccharin, sucralose and aspartame are low calorie alternatives and popular with diabetics who need to monitor their sugar intake and blood sugar levels and individuals seeking weight loss. Some artificial sweeteners have been linked to health risks including cancer.

In view of the drawbacks of various sweeteners, many consumers prefer a healthier alternative. Low-caloric sweeteners of natural origin are becoming increasingly popular.

Stevia rebaudiana is a plant species in the genus Stevia. It is also commonly known as sweet leaf or sugarleaf. The term Stevia generically refers to the plant, its' leaves and derivatives thereof. Stevia has been used for more than 1500 years by indigenous people of Brazil and Paraguay as both a sweetener and a medicine. Stevia is now widely cultivated and there are approximately 250 known species.

Stevia rebaudiana, is widely grown for its sweet leaves, which are the source of sweetener products known generically as stevia and sold under various trade names. There are various active compounds that yield a sweet flavor in stevia. These are generically known as steviol glycosides. Stevioside and Rebaudioside A are both abundant and well-known. Other steviol glycosides detected in stevia include Rebaudioside B, C, D, E, and Dulcoside A.

Steviol glycosides differ from each other not only by molecular structure, but also by their taste properties. Stevioside can be 110-270 times sweeter than sucrose. Rebaudioside A can be between 150 and 320 times sweeter. Research reports reveal Rebaudioside C to be between 40-60 times sweeter than sucrose. Dulcoside A is 30 times sweeter than sucrose.

Rebaudioside A has the least astringent, the least bitter, and the least persistent aftertaste of the major steviol glycosides. Accordingly, Rebaudioside A is the most popular steviol glycoside used in foods, beverages and sweeteners.

International patent publication WO2011048616 A2 discloses a sweetener consisting of sugar, stevia and sodium chloride (salt). The sodium chloride functions as a bitter blocker to inhibit detection of bitterness when the sweetener is consumed. However, not every consumer wants to consume a salted sweetener.

Scientific advancement in purification of Rebaudioside A has also significantly decreased bitterness in stevia-based sweeteners. Rebaudioside A's with purity <95% have very little bitterness. Further, higher purity Rebaudioside A may have increased sweetness up to 300 times sweeter than sugar. The drawback of this process is that the process is more expensive than previously employed extraction techniques, and it requires the use of a variety of chemicals that some believe could be harmful to human health.

What is desired is a sweetener that is natural, non-toxic and lacks flavor defects. What is also desired is a way of providing a sweetener that is easy to produce. What is further desired is a sweetener having a low glycemic index and fewer than 5 calories per serving.

### SUMMARY OF THE INVENTION

The present invention includes a low-calorie and natural sweetener composition and a method for producing a low-calorie sweetener composition. Preferably this composition has fewer than 5 calories per serving, and more preferably between 2.8-3.2 calories per serving and complies with “Zero” calorie labeling requirements.

One embodiment of a method of the present invention includes providing a first sweetener including table sugar having a mean particle size of between 100-350 μm in diameter and a moisture content of less than 10%, and providing a second sweetener in an aqueous solution including sugar and at least one steviol glycoside.

The second sweetener coats at least a portion of the first sweetener and has a thickness of less than 100 μm, and preferably between 1 μm to 30 μm, and more preferably between 3 μm to 11 μm. This coating thickness enables table sugar having a mean particle size of between 100-350 μm to be coated with a steviol glycoside coating to yield a zero calorie sweetener. Ideally the final composition product will have a 0.5-2% steviol glycoside content and 98-99.5% table sugar content by dry weight. More preferably the final composition product will have 1.2-1.7% steviol glycoside by dry weight. The coating must be carefully regulated to achieve the desired final composition.

There are several possible ways to coat sugar granules with an ultra-thin coating. Two are described herein, but it can be appreciated that other coating methods may be devised to accomplish similar results.

It can be appreciated that the steviol glycoside is a high intensity sweetener and that sucrose or other sugar is sweet. Only a very thin coating of steviol glycoside is needed to yield a zero calorie sweetener. The use of an ultrasonic sprayer enables this very thin coating with less waste than other known methods.

Various embodiments of the invention yield a salt and filler free sweetener composition including steviol glycoside including Rebaudioside A having a 95% or greater purity, or stevioside having a 95% or greater purity. The steviol glycoside coats granular table sugar having a mean particle size of between 100-300 μm.

In one embodiment, the steviol glycoside is purified Rebaudioside A. Ideally the steviol glycoside coating has a thickness of between 1-20 μm to yield a sweetness of the sweetener composition of 4-6 times that of table sugar having an approximately 50/50 ratio of fructose/glucose. Depending on the purity of the Rebaudioside A, the result is a composition having 0.5-1% Rebaudioside A and 99-99.5% table sugar. The coating process assures that the product is uniform in concentration and sweetness, even after handling, transportation and storage. This novel combination eliminates the need for bitter blockers and fillers, while yielding a virtually defect-free flavor. Preferably, the Rebaudioside A has a purity of 98% or greater.

In yet another embodiment, the steviol glycoside is Stevioside and the thickness of the coating is 10-20 μm.

In another embodiment, heat activating the steviol glycoside either prior to coating the table sugar or afterwards to below melting point of table sugar activates the steviol glycoside to enhance the flavour of the sugar. In one embodiment the steviol glycoside is heated to 110-140° F. In another embodiment, the Steviol glycoside is heated to 120° F. This has the effect of enhancing the sugar flavour. In a variation of this embodiment, where the table sugar is already coated with the steviol glycoside, heat activating enhances the aroma of the composition.

The composition yields a sweetener composition 4-8 times the sweetness of sucrose. Preferably, the sweetness range is 4-5 time the sweetness of sucrose. The sweetener composition claims that has less than 5 calories per serving to enable a “Zero” calorie claim, and being equal in sweetness to one serving of sucrose.

### BRIEF DESCRIPTION OF THE DRAWINGS

FIG. 1 is a flowchart of a method in accordance with the present invention.

### DETAILED DESCRIPTION

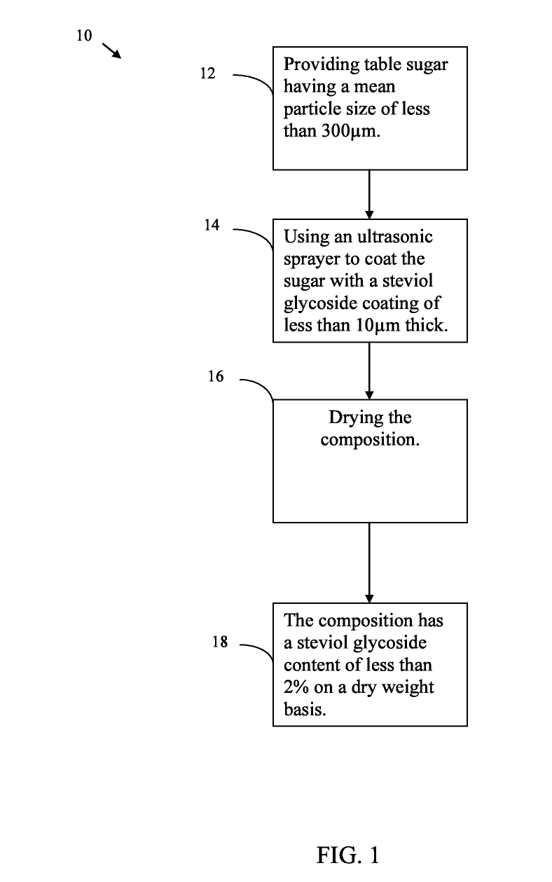

FIG. 1 is a method generally designated with the reference numeral 10. The method 10 yields a sweetener composition. The method 10 includes the step 12 of providing table sugar having a mean particle size of less than 300 μm, the step 14 of using an ultrasonic sprayer to coat the table sugar with a steviol glycoside coating having an average thickness of less than 10 μm. The step 16 dries the composition. The composition has a steviol glycoside content of less than 2% on a dry weight basis.

In an embodiment of the invention that yields a composition that is 4 times sweeter than sucrose, the steviol glycoside content of the composition is 1.3%. This embodiment has approximately 4 calories per serving. In an embodiment of the invention that yields a composition that is 5 times sweeter than sucrose, the steviol glycoside content of the composition is 1.7% and has approximately 3 calories per serving.

The present invention includes a sweetener having less than 4-5 calories per serving. Each serving has about the equivalent sweetness as a serving of sucrose. This is achieved by a novel process which coats granules of table sugar having a specified average granular size. The coating includes steviol glycoside.

In one embodiment of the invention, the table sugar has a granule size having a mean particle size in the range of 100-600 μm. Preferably the granule size has a mean particle size of 100-300 μm, and more preferably the mean particle size is between 125-175 μm. Ideally the mean particle size is 150 μm. The term mean particle size means that the particle size is calculated as the hypothetical mesh aperture of a sieve that allows 50% of the sugar to pass.

The invention applies a coating to each granule in order to increase the sweetness of each granule to yield a sugar-stevia product that is 3 to 10 times sweeter than sugar and preferably closer to 4 to 5 times the sweetness of sugar.

The coating in one embodiment of the invention is approximately 1-10 μm thick and fully coats each sugar granule. The coating in another embodiment of the invention is approximately 10-20 μm thick and partially coats each sugar granule. The coating thickness varies with the purity and sweetness of the stevia mixture, and the size of the sugar granule.

In an alternate embodiment, the table sugar granules are coated, having 90% (on average) of the granule surface area of the sugar covered by the coating. In another embodiment, an average of 25% of the surface area of the sugar granules is coated. It can be appreciated that the coating average surface area coverage can vary depending on the thickness of the granules and the thickness of the coating.

In one embodiment the composition is 92-99.5% table sugar granules. The table sugar granules are dry, having a moisture content of less than 10%, preferably less than 5%, and more preferably within the range of 0.5-3%. The composition has 8-0.5% steviol glycosides. Preferably the steviol glycoside content is less than 1% of the composition.

Table sugar is defined herein to include glucose, fructose, dextrose, sucrose, or any combination thereof. Table sugar can be made from sugar cane, beets, or other plants. Preferably, the table sugar is has a crystalline structure with an approximate 50/50 ratio of glucose and fructose. It can be appreciated that this ratio can vary to include any ratio that enables commercial scale distribution of the table sugar.

The table sugar granules are coated with a stevia mixture, particularly a steviol glycoside. More preferably the steviol glycoside is presented in an aqueous solution.

An embodiment of the composition of the present invention is dry (having less than 10% moisture content). Hydration of this composition is enabled by mixing with water. The dry composition includes 1%-8% of dry steviol glycoside and 92%-99% table sugar, by volume. Accordingly, where the steviol glycoside solution coats the sugar granules, and the sugar granules have a mean granular diameter of 100-300 μm, whereby the composition is 4 to 5 times sweeter than table sugar. In this way, one serving of the composition has approximately 75%-85% less calories than table sugar per serving.

Preferably, the invention includes a dry composition having between 1-3% steviol glycoside and 97-99% table sugar by dry weight. More preferably, the dry composition is 0.5-1.5% steviol glycoside and 98.5-99.5% table sugar by dry weight, wherein the table sugar is at least partially coated with the steviol glycoside. The composition preferably has 3-12% moisture content in one embodiment of the invention, and preferably 3-5% moisture content.

In another embodiment the composition yielded by the present invention is a liquid made by combining the dry composition of the invention with water. The liquid composition has a concentration of steviol glycoside to table sugar by volume within the range of 3:100 to 1:100.

### Steviol Glycoside Spray Solution

Preparation of the steviol glycoside solution for spraying onto the table sugar includes heating the steviol glycoside solution to improve solubility of the steviol glycoside. It can be appreciated that addition of a solubility enhancement agent can be utilized to maximize the steviol glycoside concentration in the spray solution.

In one embodiment the spray solution includes an aliquot of sugar to enhance adhesion of the steviol glycoside to the table sugar. The steviol glycoside solution is heated to 78-107° C. for a period of about 8-20 minutes to prepare the spray solution. It can be appreciated that any food-grade adhesion-enhancing agent may be combined with the steviol glycoside solution.

Applying the steviol glycoside solution is accomplished in accordance with one aspect of the invention by a fluid bed coating system or by use of an ultrasonic coating process. It can be appreciated that other processes may be developed to accomplish the desired coating characteristics and achieve the thickness ranges desired herein.

### Ultrasonic Sprayer

An embodiment of the present invention utilizes an ultrasonic sprayer to deliver and apply the second coating. The ultrasonic spray includes a spray head that precisely applies the second sweetener to the first sweetener. An advantage of the use of an ultrasonic sprayer is that there is little waste due to over coating. Another advantage is that the thickness of the second coating can be precisely regulated yielding a coated granule that is very close to the size of the uncoated granules. A further advantage is that the sprayer is less likely to be clogged than traditionally used nozzles in a fluid bed processor.

The spray head includes an ultrasonic transducer with a spray forming tip, an ultrasonic generator, an external liquid applicator, a precision liquid delivery system, and air directors.

The ultrasonic transducer contains a spray-forming tip that preferably vibrates at an ultrasonic frequency of greater than 20 kHz. The ultrasonic transducer is resonant at a particular ultrasonic frequency, preferably between 20 kHz and 100 kHz. More preferably the ultrasonic transducer resonates at between 3 μm 5 kHz and 60 kHz, and preferably 45 kHz.

The ultrasonic transducer is driven by an ultrasonic generator. The ultrasonic generator has a frequency corresponding to the frequency of the ultrasonic transducer. The particular ultrasonic frequency is selected based upon the granule size and composition of the first sweetener.

The amplitude of vibration of the spray-forming tip is also set with the ultrasonic generator and may be fixed, or vary. In one embodiment a granule size detector detects a mean granule size and communicates the granule size to a controller, the controller communicates with the ultrasonic generator to optimize the amplitude of the ultrasonic vibration.

The second sweetener is a liquid that is delivered to the spray-forming tip on the ultrasonic transducer with an external liquid applicator. The second sweetener is stored in a reservoir and precisely fed to the liquid applicator through the use of a precision liquid delivery system having flow sensors and viscosity sensors in communication with the controller.

The ultrasonic vibrations of the spray-forming tip break up the liquid into small drops and propel them from the tip in the form of a spray. The width of the spray pattern produced is equal to the width of the spray-forming tip. In one embodiment, the spray forming tip is between 1 to 100 mm in width, and is preferably between 2 mm to 20 mm in width to enable commercially available spray forming tips to be used.

Air directors communicate with the controller to regulate the shape, velocity and acceleration of the ultrasonically produced spray. The air directors impinge a jet of sterile air on the spray tip of the spray head. The resulting airflow entrains and expands the spray to produce a flat (rectilinear) pattern up to five (5) times the width of the pattern produced by the ultrasonic energy alone.

Preferably the present invention includes a conveyer that moves the first sweetener past an array of the ultrasonic sprayers in accordance with the present invention. In this embodiment at least one side of the first sweetener is coated with the second sweetener. It can be appreciated that the crystalline form of sucrose is multi-faceted and that multiple edges and facets of each crystal are coated with the second sweetener by the ultrasonic sprayer.

### Fluid Bed Processor

In an embodiment of the invention, the coating is applied by a fluid bed processor. The fluid bed processor system circulates heated air in a chamber to agitate the sugar granules, and simultaneously heats and sprays the steviol glycoside solution from the bottom of the chamber to uniformly coat the sugar granules. Heating the steviol glycoside solution enables optimal viscosity of the solution as well as adherence of the solution to the granules.

Calculating the volume of the coating can utilize the formula:

$$\frac{4}{3} {π ( {r}_{1} + {r}_{2} )}^{3} - \frac{4}{3} π {r}_{1}^{3} = {V}_{c}$$

where r₁ is the radius of the sugar granule and r₂ is the radius of the coated granule, and V_{c} is the volume of the coating. Accordingly thickness of the coating (or range thereof) can be determined for any granule size, knowing the desired volumetric ratio of the sugar/stevia glycoside ratio.

Drying the granules after application of the steviol glycoside solution is accomplished in a separate fluid bed drying apparatus, or in the same the fluid bed coating system, which is adapted to perform a drying function.

Accordingly, a method for producing a low-calorie sweetener composition that has no fillers, and has less than 5 calories per serving, and virtually no flavor defects includes:

a) providing a first sweetener including table sugar having a mean particle size of between 100-350 μm in diameter;

b) providing a second sweetener in an aqueous solution including at least one steviol glycoside;

c) heating the second sweetener to above 78° C. and pressurizing the second sweetener in a pressure vessel at above 1 atm of pressure to enable atomization;

e) agitating the first sweetener in a fluid bed processor;

f) coating the first sweetener with the second sweetener by spraying in an upward direction to yield a low-calorie sweetener composition;

h) drying the low-calorie sweetener composition to between 0.5-10% moisture content to yield a sweetener composition having less than 5 calories per serving.

The method includes establishing an atomization pressure between 14.7 psi-50 psi, and preferably 25 psi atomizing air pressure and 15 psig liquid pressures in a fluid bed processor. The method of spray can be top spray, or bottom spray or both. Preferably top spray is used.

Excipient distributions are variable depending on granular size of sugar granules, and the desired caloric content of the product.

Testing conducted utilized a range from 2-4 tablespoons of Rebaudioside A having 98% purity (RA98), which was distributed over approximately 7-8 pounds of table sugar. The Rebaudioside A is dissolved in water at a concentration of 5 Tbsp/liter in order to achieve a viscosity optimal for spraying. No fillers or salts are added.

In general, RA98 tends to create suspended solids in solution with water, as opposed to lower grades which readily dissolve. The effective viscosity of the steviol glycoside solution, particularly the RA98 mixture, creates a unique problem because the spray is viscous. Little of the steviol glycoside solution is needed relative to other coating technologies because of the intense sweetening capabilities of RA98. Accordingly the RA98 steviol glycoside solution is diluted to 5 Tbsp/liter. The substrate mixing that occurs on a fluid bed spread the spray evenly and provides for good particle-to-particle transfer of the coating, while the heated air dries away water and prevents the product from dissolving or “clumping.”

Various examples of the sweetener compositions in accordance with the present invention are provided. Although this patent application describes various methods and compositions, it can be appreciated that the scope of the invention encompasses additional examples. Only a few of which are articulated as examples. Accordingly, the scope of the invention is defined by the appended claims.

### Example 1

A sweetener composition that is about five time sweeter than sugar uses a 95% or greater purity Rebaudioside A coating over granular sugar, where the sugar content 97-98.5%, and the Rebaudioside A content is between 1% to 3% by volume. The granular sugar has a mean particle size of between 100-300 μm, and less than 5 calories per serving where a serving has a sweetness equivalent to the sweetness of sucrose.

### Example 2

A sweetener composition that is about five times sweeter than sucrose uses a 98% or greater purity Rebaudioside A coating over granular table sugar, where the sugar content is between 98-99%, and the Rebaudioside A content is 1-2% by volume. The granular sugar has a mean particle size of between 100-150 μm, and less than 5 calories per serving. The coating is between 1-5 μm in thickness.

### Example 3

A sweetener composition that is about five times sweeter than sucrose uses a stevioside coating over granular table sugar, where the sugar content is 92-94%, and has a stevioside content of 6-8% by volume. The coating is less than 20 μm in thickness.

### Example 4

A sweetener composition uses a 98% or greater purity Rebaudioside A coating over granular table sugar, where the table sugar content 98-99%, and the Rebaudioside A content is 1-2% by volume. The granular sugar has a mean particle size of between 100-150 μm, and less than 5 calories per serving. The coating is between 0.1-5 μm in thickness.

1. A method for producing a sweetener composition comprising:
a) providing a first sweetener including table sugar having a mean particle size of between 100-350 μm in diameter;
b) providing a second sweetener in an aqueous solution including at least one steviol glycoside;
c) using an ultrasonic sprayer to coat the first sweetener with the second sweetener, the ultrasonic spray has an ultrasonic transducer, the ultrasonic transducer resonates at between 35 kHz and 60 kHz; and
d) drying the sweetener composition to between 0.5-5% moisture content to yield a sweetener composition.

2. The method as set forth in claim 1, wherein the coating thickness is between 0.5-20 μm.

3. A method as set forth in claim 1, wherein the coating thickness is between 0.5-2 μm.

4. A method as set forth in claim 3, wherein the steviol glycoside is Stevioside.

5. A method as set forth in claim 3, wherein the steviol glycoside is Rebaudioside A.

6. A method for producing a sweetener composition comprising:
a) providing a first sweetener including table sugar having a mean particle size of between 100-350 μm in diameter;
b) providing a second sweetener in an aqueous solution, the second sweetener includes a steviol glycoside;
c) coating the first sweetener with the second sweetener with an ultrasonic sprayer to yield a sweetener composition;
d) drying the sweetener composition; and
wherein the sweetener composition has between 0.5-2% steviol glycoside on a dry weight basis.

7. The method as set forth in claim 6, wherein the coating thickness is between 1-20 μm.

8. The method as set forth in claim 7, wherein the second sweetener partially coats the first sweetener.

9. The method as set forth in claim 8, wherein the steviol glycoside is Stevioside.

10. The method as set forth in claim 8, wherein the steviol glycoside is Rebaudioside A.

11. The method as set forth in claim 7 further comprising:
heating the composition to between 110-140° F. to heat activate the composition to improve flavor.

12. A sweetener composition, comprising:
table sugar having a mean particle size of less than 300 μm,
steviol glycoside coating the table sugar, where the coating has thickness of under 10 μm, and the sweetener composition has less than 2% steviol glycoside content on a dry weight basis.

13. A sweetener composition as set forth in claim 12, wherein the coating has been applied by an ultrasonic sprayer having an ultrasonic transducer resonating at between 35 kHz and 60 kHz.

14. A sweetener composition as set forth in claim 13, wherein the thickness of the coating is less than 5 μm and the mean particle size of the table sugar is less than 150 μm.

15. A sweetener composition as set forth in claim 14, wherein the steviol glycoside partially coats the granular sugar.

16. A sweetener composition as set forth in claim 15, wherein the sweetener composition has a sweetness of 4-8 times the sweetness of sucrose.

17. A sweetener composition as set forth in claim 16, wherein the sweetener composition has a moisture content of less than 5%.
